(19) United States
(12) Patent Application Publication
(10) Pub. No.: US 2026/0087077 A1
(43) Pub. Date: Mar. 26, 2026

(54) METHODS FOR AUTOMATED OUTREACH COMMUNICATION MODELING USING ARTIFICIAL INTELLIGENCE AND DEVICES THEREOF

(71) Applicant: JONES LANG LASALLE IP, INC., Chicago, IL (US)

(72) Inventors: Ondrej Kovasnovski, Cupertino, CA (US); Jan Konopásek, Prague (CZ); Lane Cochrane, Kirkland (CA); Roman Bosak, Ostrava (CZ); Mark Holmes, Seattle, WA (US); Pavel Dergel, Jistebnik (CZ); Sylvain Laporte, Quebec (CA); Antonin Grund, Ostrava (CZ)

(21) Appl. No.: 18/892,244

(22) Filed: Sep. 20, 2024

(51) Int. Cl. G06F 16/951; G06F 16/9536

(52) U.S. Cl. CPC G06F 16/951; G06F 16/9536

(57) ABSTRACT

A method, system, and non-transitory computer readable medium includes generating, using a machine learning model, a summary of relevant data scraped from online news data and extracting topics from the summary of the relevant data. Then the method can include identifying suggested content offerings based on context data. The suggested content offerings can be aligned with the extracted topics and the context data can be received from a computing device.

Then the method can include generating a communication based on a prompt. The prompt can be generated using the context data, the topics, the suggested content offerings, or combinations thereof. Lastly, the method can include providing, by the computing device to a client device, a graphical user interface comprising the communication.

### FIELD

This technology generally relates to automating outreach communications and, more particularly, to methods for automating outreach communication modeling using artificial intelligence and devices thereof.

### BACKGROUND

In commercial real estate, current methods for broker outreach to prospective real estate occupants are ineffective, time-consuming, and inefficient. The effectiveness is limited by the amount of time consumed by preparing and sending communications to prospects. With more time, or more efficient communication methods, more outreach can occur, leading to a higher volume of responses and meetings even assuming a constant response rate. Additionally, crafting effective messages can take even more time to research information regarding the prospects and provide a value proposition that can be persuasive to move an engagement forward. While generic scripts and template communications can improve efficiency in outreach generation, the resulting communications are not personalized and have a low response rate. Automation can also improve efficiency, but conventional automatic outreach generation methods have limited effectiveness. Generating messages that do not align with prospecting best practices and are not sufficiently personal or persuasive do not result in a high positive response rate. This inefficiency is further compounded by the lack of integration between various data collection tools and platforms, leading to fragmented and inconsistent data sets that hinder comprehensive analysis and decision-making. Therefore, there is a need for a new, effective automated outreach communication model.

### SUMMARY

A method that generates outreach communications using artificial intelligence includes generating, using a machine learning model, a summary of relevant data scraped from online news data and extracting topics from the summary of the relevant data. Then the method can include identifying suggested content offerings based on context data. The suggested content offerings can be aligned with the extracted topics and the context data can be received from a computing device. Then the method can include generating a communication based on a prompt. The prompt can be generated using the context data, the topics, the suggested content offerings, or combinations thereof. Lastly, the method can include providing, by the computing device to a client device, a graphical user interface comprising the communication.

A non-transitory computer readable medium having stored thereon instructions comprising machine executable code which when executed by at least one processor, causes the processor to generate, using a machine learning model, a summary of relevant data scraped from online news data and extract topics from the summary of the relevant data. Then the executable code which when executed by at least one processor, causes the processor to then identify suggested content offerings based on context data. The suggested content offerings can be aligned with the extracted topics and the context data can be received from a computing device. Then the executable code which when executed by at least one processor, causes the processor to then generate a communication based on a prompt. The prompt can be generated using the context data, the topics, the suggested content offerings, or combinations thereof. Lastly, the executable code which when executed by at least one processor, causes the processor to then provide, by the computing device to a client device, a graphical user interface comprising the communication.

A computing apparatus including at least one of configurable hardware logic configured to be capable of implementing or a processor coupled to a memory and configured to execute programmed instructions stored in the memory to generate, using a machine learning model, a summary of relevant data scraped from online news data and extract topics from the summary of the relevant data. Then the executable code which when executed by the processor, causes the processor to then identify suggested content offerings based on context data. The suggested content offerings can be aligned with the extracted topics and the context data can be received from a computing device. Then the executable code which when executed by the processor, causes the processor to then generate a communication based on a prompt. The prompt can be generated using the context data, the topics, the suggested content offerings, or combinations thereof. Lastly, the executable code which when executed by at the processor, causes the processor to then provide, by the computing device to a client device, a graphical user interface comprising the communication.

This technology provides a number of advantages including providing a method, non-transitory computer readable medium, and apparatus that enable the generation of personalized and effective broker outreach communications. This technology is able to streamline the outreach process, enhance message personalization, and increase engagement rates. Examples of this technology enable the generation of customized messages based on detailed prospect data, resulting in higher response rates and more successful engagements. Examples of the claimed technology also are able to optimize communication workflows by dynamically generating persuasive and personalized messages that align with prospecting best practices. This claimed technology can efficiently correlate a broker's outreach strategy with prospect data to generate effective communication scenarios and strategies. This type of technology can enable the generation of personalized and persuasive outreach messages in real time with accurate, customized data, which has not previously been available.

### BRIEF DESCRIPTION OF THE DRAWINGS

FIG. 1 is a block diagram of an example of an environment with a composing computing system configured to generate outreach communications;

FIG. 2A is a block diagram illustrating an example of an architecture of a composing computing system;

FIG. 2B is a block diagram illustrating an example of an architecture of a database;

FIG. 2C is a block diagram illustrating an example of an architecture of a client device;

FIG. 3 is an exemplary flowchart of an exemplary method of generating outreach communications;

FIG. 4 is an exemplary environment of a flow that includes a composer acting as a composing computing system; and

FIG. 5 is an exemplary interface of an input screen to collect lead data, context data, selected topics, and additional data from a user of the composer computing system.

### DETAILED DESCRIPTION

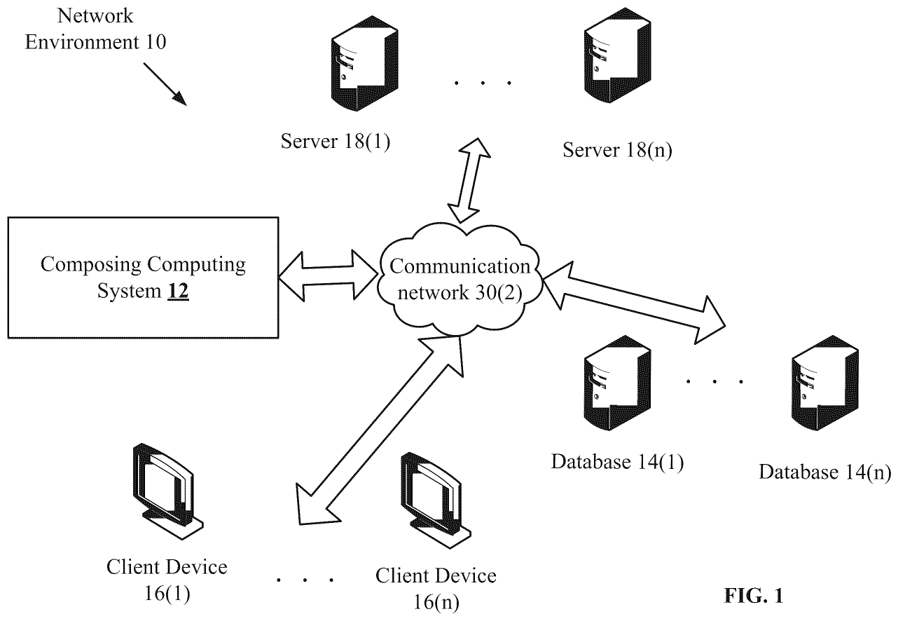

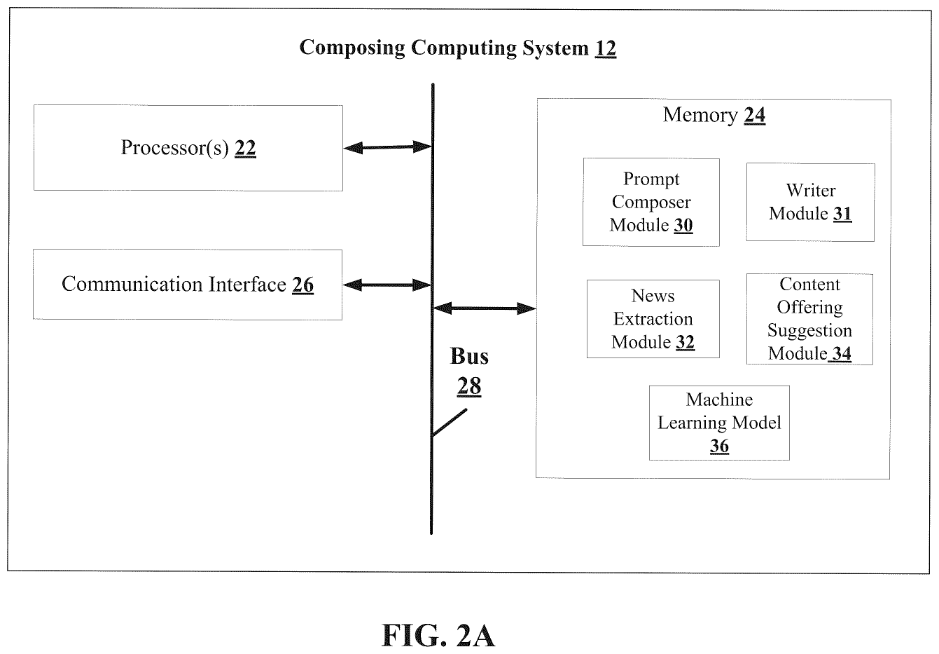

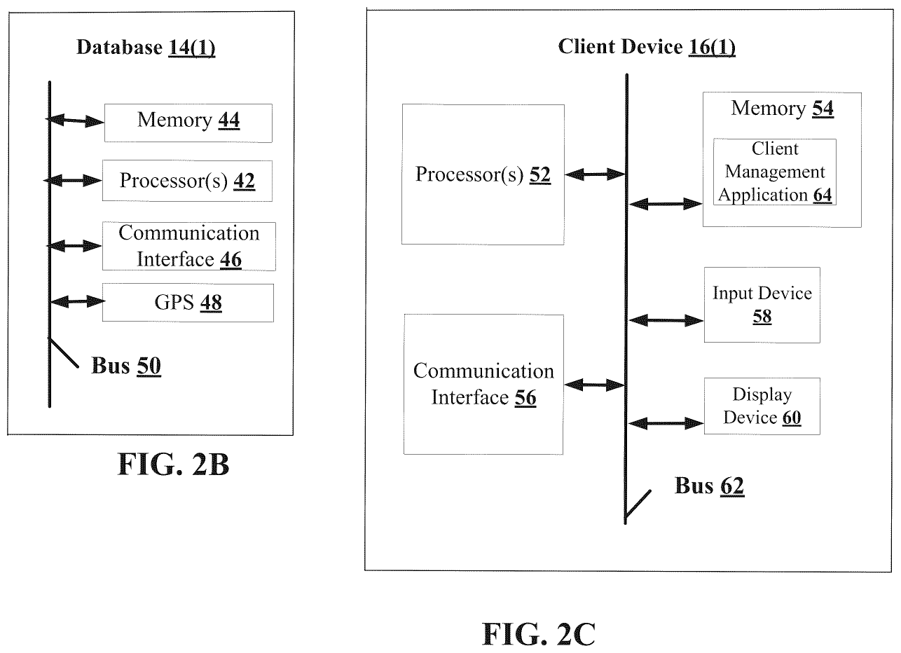

An environment 10 with an exemplary composing computing system 12 is shown in FIGS. 1-2C. In this example, the environment 10 includes the composing computing system 12, a plurality of databases 14(1)-14(n), a plurality of client devices 16(1)-16(n), and a plurality of servers 18(1)-18(n), although the environment may comprise other types and/or numbers of other systems, devices, components, and/or other elements in other configurations. This technology provides a number of advantages including providing systems, methods, and non-transitory computer readable media that enable the generation of personalized and effective broker outreach communications. This technology is able to streamline the outreach process, enhance message personalization, and increase engagement rates.

Referring to more specifically to FIGS. 1-2A, in this example, the composing computing system 12 includes one or more processor(s) 22, a memory 24, and/or a communication interface 26, which are coupled together by a bus or other communication link 28, although the composing computing system 12 can include other types and/or numbers of elements in other configurations.

The processor(s) 22 of the composing computing system 12 may execute programmed instructions stored in the memory of the composing computing system 12 for any number of functions and other operations as illustrated and described by way of the examples herein. The processor(s) 22 of the composing computing system 12 may include one or more CPUs or general purpose processors with one or more processing cores, for example, although other types of processor(s) can also be used.

The memory 24 of the composing computing system 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 24.

Accordingly, the memory 24 of the composing computing system 12 can store one or more applications that can include computer executable instructions that, when executed by the composing computing system 12, cause the composing computing system 12 to perform actions, such as to generate outreach communications, and other actions as described and illustrated in the examples below with reference to FIGS. 1-8. The application(s) can be implemented as modules, programmed instructions, or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the composing computing system 12 itself, may be located in virtual server(s) running in a cloud-based computing environment rather than being tied to one or more specific physical computing devices. Also, the application(s) may be running in one or more virtual machines (VMs) executing on the composing computing system 12. Additionally, in one or more embodiments of this technology, virtual machine(s) running on the composing computing system 12 may be managed or supervised by a hypervisor.

In this particular example, the memory 24 of the composing computing system 12 may include a prompt composer module 30, a writer module 31, a news extraction module 32, an content offering suggestion module 34, and a machine learning model (MLM) 36 which may be executed as illustrated and described by way of the examples herein, although the memory 24 can for example include other types and/or numbers of modules, platforms, algorithms, programmed instructions, applications, or databases for implementing examples of this technology. In some embodiments, the prompt composer module 30, the writer module 31, the news extraction module 32, the content offering suggestion module 34, and/or the MLM 36 can be one unified module that performs the functions of the prompt composer module 30, the writer module 31, the news extraction module 32, the content offering suggestion module 34, and/or the MLM 36.

The prompt composer module 30 may comprise executable instructions that are configured to interact with any of the client devices 16(1)-16(n) to create prompts and interface with other modules for the generation of personalized and effective prospect communications. The prompt composer module 30 may also comprise executable instructions that are configured to execute other operations and/or functions as illustrated and described in greater detail by way of the examples herein, although this module may have executable instructions that are configured to execute other types and/or functions or other operations to facilitate examples of this technology, such as generating prompts based on context data, including selected topics and suggested content offerings for use as inputs for the MLM 36, by way of example.

The writer module 31 may comprise executable instructions that are configured to generate outreach communications using output from the MLM 36, as illustrated, and described in greater detail by way of the examples herein, although this module may have executable instructions that are configured to execute other types and/or functions or other operations to facilitate examples of this technology.

The news extraction module 32 may comprise executable instructions that are configured to obtain online news data based on lead data for use by the MLM 36 to then scrape, summarize, and extract topics from the online news data. The news extraction module 32 may also comprise executable instructions that are configured to execute other operations and/or functions as illustrated and described in greater detail by way of the examples herein, although this module may have executable instructions that are configured to execute other types and/or functions or other operations to facilitate examples of this technology.

The content offering suggestion module 34 may comprise executable instructions that are configured to identify suggested content offerings that can be selected by the broker for inclusion in prompts, as illustrated and described in greater detail by way of the examples herein, although this module may have executable instructions that are configured to execute other types and/or functions or other operations to facilitate examples of this technology, such as extracting available content offerings from one of the plurality of databases 14(1)-14(n), by way of example.

The MLM 36 may be one or more machine learning models 36. In one example, one of the MLMs 36 may be a natural language processor or a large language model. In this example, one or more developers may fine-tune a pre-trained LLM with data to generate a fine-tuned LLM for specific use cases. Although not illustrated, the plurality of servers 18(1)-18(n) may host and/or manage a plurality of LLMs which may be pre-trained general purpose LLMs or fine-tuned LLMs. The plurality of servers 18(1)-18(n) may be a cloud-based server or an on-premises server. The fine-tuned LLMs may be accessed using an application programming interface (API) for use in applications. In another example, the fine-tuned LLM may be hosted by the plurality of servers 18(1)-18(n) and managed remotely by the composing computing system 12.

The MLM 36 can also be a natural language processor or a type of artificial intelligence-machine learning (AI/ML) model that is used to process natural language data for tasks such as natural language processing, text mining, text classification, machine translation, question-answering, response generation, or the like. The MLM 36 uses deep learning or neural networks to learn language features from large amounts of data. The MLM 36 is, for example, trained on a large dataset and then used to generate predictions or generate features from unseen data. The MLM 36 can be used to generate language features such as word embeddings, part-of-speech tags, named entity recognition, sentiment analysis, or the like. Unlike traditional rule-based NLP systems, the MLM 36 does not have to rely on pre-defined rules or templates to generate responses. Instead, the MLM 36 can use a probabilistic approach to language generation, where the MLM 36 can calculate the probability of each word in a response based on the patterns the MLM 36 learned from the training data.

The composing computing system 12 may contain programs that train, implement, store, receive, retrieve, and/or transmit one or more MLMs 36. MLMs 36 may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The composing computing system 12 may be configured to adjust model parameters during training. Model parameters may include weights, coefficients, offsets, or the like. Training may be supervised or unsupervised.

The composing computing system 12 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The composing computing system 12 may be configured to optimize statistical models using known optimization techniques.

The composing computing system 12 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The composing computing system 12 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some examples, the composing computing system 12 is configured to generate and/or train the MLM 36 to classify a dataset, consistent with disclosed examples.

The communication interface 26 of the composing computing system 12 operatively couples and communicates between the composing computing system 12 and the one or more of databases 14(1)-14(n), the one or more of the client devices 16(1)-16(n), and the one or more servers 18(1)-18(n), although other types and/or numbers of connections and/or communication networks can be used.

While the composing computing system 12 is illustrated in this example as including a single device, the composing computing system 12 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the composing computing system 12.

Additionally, one or more of the devices that together comprise the composing computing system 12 in other examples can be standalone devices or integrated with one or more other devices or apparatuses, such as in one of the server devices or in one or more computing devices for example. Moreover, one or more of the devices of the composing computing system 12 in these examples can be in a same or a different communication network including one or more public, private, or cloud networks, for example.

Although an exemplary composing computing system 12 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in this composing computing system 12, such as the composing computing system 12, for example, may be configured to operate as virtual instances on the same physical machine. In other words, by way of example one or more of the composing computing system 12 may operate on the same physical device rather than as separate devices communicating through communication network(s). Additionally, there may be more or fewer composing computing system 12 than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to conduct steps necessary to implement the methods of the examples of this technology that are described and illustrated herein.

Referring to FIGS. 1 and 2B, the plurality of databases 14(1)-14(n) may comprise a variety of different types and/or numbers of systems, devices, or other things in the environment 10, such as a variety of different online news data (e.g., news articles), context data, lead data, content offerings, response data, data, or combinations thereof by way of example only. In this example, the composing computing system 12 has a table, a data structure, or other manner organizing the online news data, context data, lead data, content offerings, response data, data, or combinations thereof by way of example, although other manners for categorizing and organizing the data can be used. In this example, each of the databases 14(1)-14(n) at least have the same following structure and operation as shown in the example of the database 14(1) shown in FIG. 2B, although databases 14(1)-14(n) with other types and/or numbers of other systems, devices, components, and/or other elements may be used. Additionally, in this example, the database 14(1) has one or more processors 42, a memory 44, a communication interface, and a global positioning system (GPS) device 48 which are coupled together by a bus or other communication link 50, although each database of data could have other types and/or numbers of systems, devices, components and/or other elements in other configurations.

Referring to FIGS. 1 and 2C, the plurality of client devices 16(1)-16(n) in this example includes any type of computing device that can participate in the generation of outreach communications in an environment 10 with a client management application 64, such as mobile computing devices, desktop computing devices, laptop computing devices, tablet computing devices, virtual machines (including cloud-based computers), or the like. In this example, each of the client devices 16(1)-16(n) at least have the same following structure and operation as shown in the example of the client device 16(1) shown in FIG. 2C, although client devices with other types and/or numbers of other systems, devices, components, and/or other elements may be used. Additionally in this example, the client device 16(1) includes one or more processor 52, a memory 54, a communication interface 56, an input device 58, and a display device 60, which are coupled together by a bus or other communication link 62, types and/or numbers of systems, devices, components, or other elements in other configurations. Additionally, in this example the memory 54 includes a client management application 64 which enables the client 16(1) to interact with the composing computing system 12 and one or more of the databases 14(1)-14(n) as illustrated and described by way of the examples herein, although the memory 54 can include other programmed instructions, modules, applications, or other data for example.

The plurality of servers 18(1)-18(n) in this example includes one or more processors, a memory, and a communication interface, which are coupled together by a bus or other communication link, although other numbers and/or types of network devices could be used. In this example, the servers 18(1)-18(n) can be located at different locations and may each process requests received from the composing computing system 12 and/or the client devices 16(1)-16(n) via the communication network(s) 20. Various data and other applications may be operating on the composing computing system 12 and transmitting data (e.g., files or Web pages) to the composing computing system 12 and/or the client devices 16(1)-16(n). The servers 18(1)-18(n) may be hardware or software or may represent a system with multiple servers in a pool, which may include internal or external networks.

An exemplary method for generating outreach communications using machine learning models 36 in the environment 10 with the composing computing system 12 and one or more of the client devices 16(1)-16(n) will now be described with reference to FIGS. 1-8.

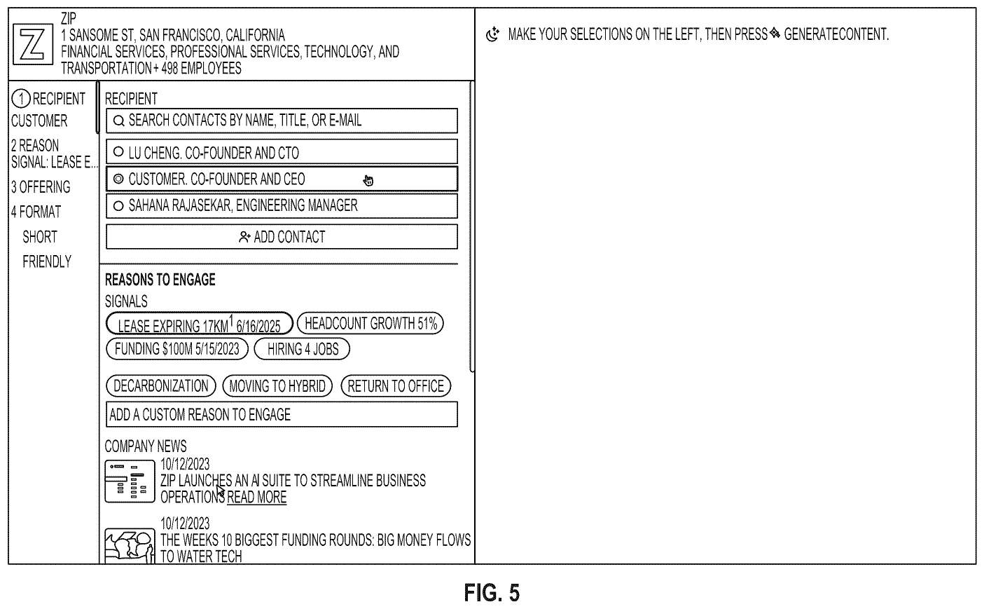

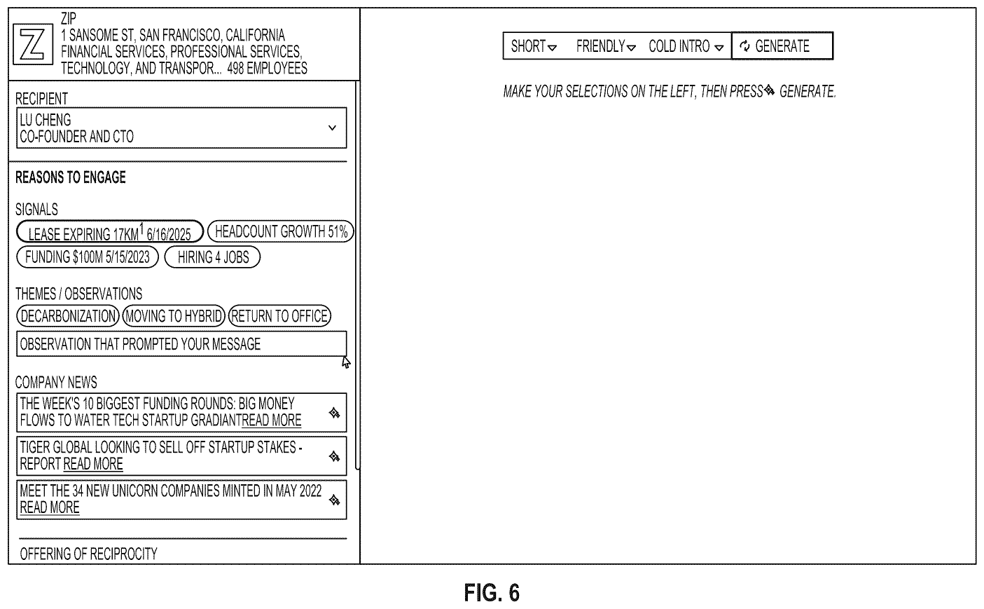

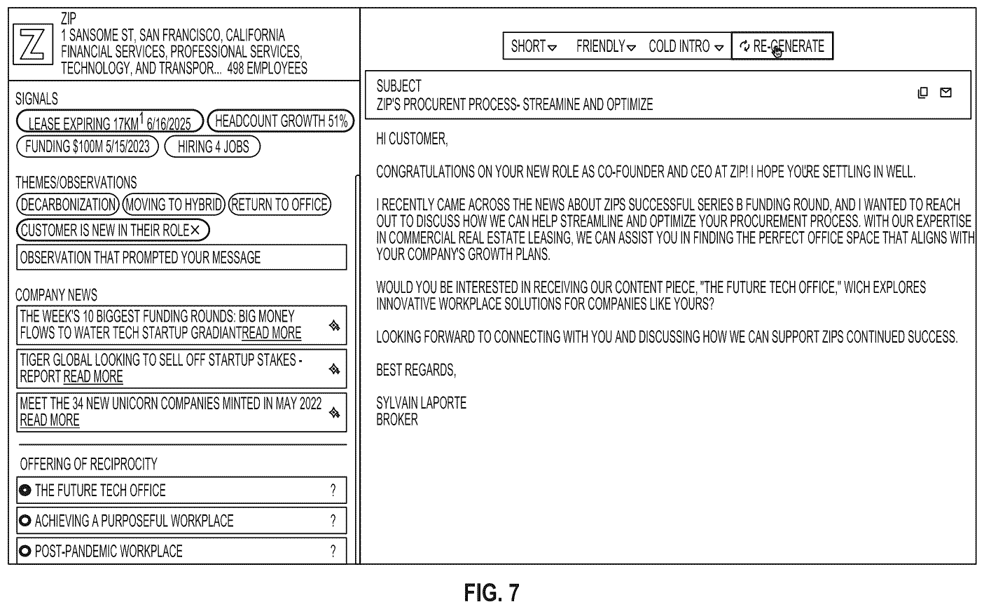

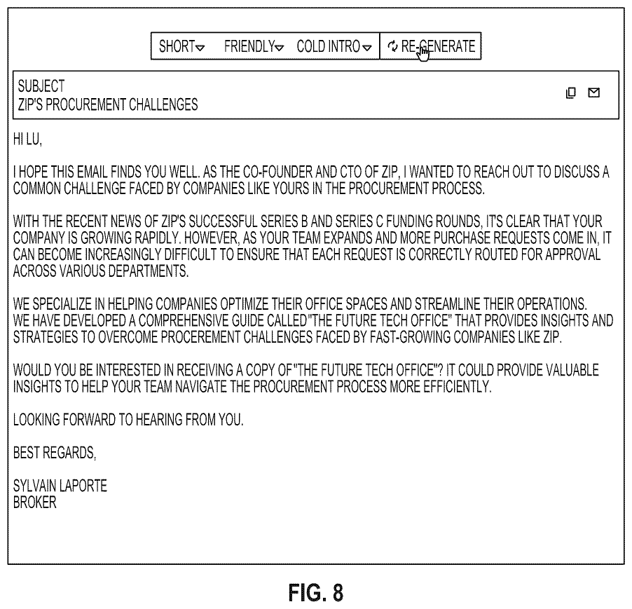

In a non-limiting example, the composing computing system 12 can generate outreach communications by integrating with an application programming interface (API) by sending a call to the API to receive lead data. The lead data can identify a prospect for the communication. The lead data can comprise a contact name, a description, company details, industries, or other information known in the art of the prospect. In some examples, the composing computing system 12 can receive the prospect from a user of the client device at one of the plurality of client devices 16(1)-16(n) as illustrated in FIG. 5. A user of the client device at one of the plurality of client devices 16(1)-16(n) can be a broker, and the client device at one of the plurality of client devices 16(1)-16(n) can be known as a broker user device.

In some examples, the composing computing system 12 can execute the prompt composer module 30 to begin a process of generating a prompt. The prompt composer module 30 may be configured to begin the process of generating a prompt by communicating with the news extraction module to interface with third party data sources to obtain online news data. In some examples, the news extraction module can obtain the online news data based on the lead data. In other examples, the composing computing system 12 can execute the news extraction module 32 to interface with third party data sources to obtain the online news data based on the lead data. The news extraction module 32 can be configured to retrieve the online news data from a database at one of the plurality of databases 14(1)-14(n) based on the lead data. The composing computing system 12 can then use a machine learning model (MLM) 36 to scrape, summarize, and extract topics from the online news data.

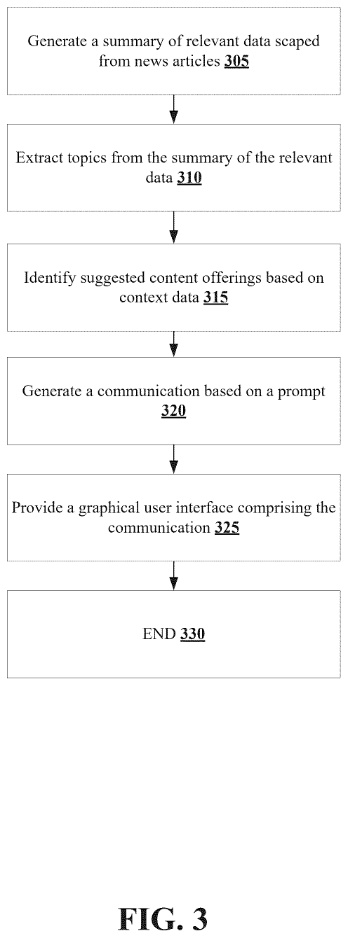

In one example, the trained MLM 36 can be configured to scrape online news data by utilizing web scraping tools and libraries to collect relevant data from the third party sources. The MLM 36 can also be configured to collect the relevant data from the online news data retrieved from the news extraction module 32. Referring more specifically to FIG. 3, in step 305, the composing computing system 12 can use the MLM 36 to generate a summary of the relevant data scraped from online news data. The MLM 36 can be configured to employ natural language processing (NLP) techniques to summarize the relevant data by distilling main points and key information of the relevant data into concise summaries. The natural language processor can be configured to process natural language data for tasks such as natural language processing, text mining, text classification, machine translation, question-answering, response generation, or the like. The natural language processor can use deep learning or neural networks to learn language features from large amounts of data. The natural language processor can be trained on a large dataset and then used to generate the summaries.

In step 310, the composing computing system 12 can extract topics from the summary of the relevant data by using the MLM 36. The MLM 36 can also be configured to use topic modeling algorithms to identify and extract topics discussed in the relevant data or the online news data. The composing computer system 12 can generate a graphical user interface (GUI) comprising the extracted topics and/or the online news data as illustrated in FIGS. 5-7. The composing computer system 12 can provide the GUI to the client device at one of the plurality of client devices 16(1)-16(n). The composing computer system 12 can receive from the client device at one of the plurality of client devices 16(1)-16(n) selected topics or selected online news data from among the extracted topics or the online news data. The composing computing system 12 can use the selected topics or selected online news data later to generate a prompt for the MLM 36.

In a non-limiting example, as illustrated in FIG. 5, the composing computing system 12 can also receive context data (such as signals) from the client device at one of the plurality of client devices 16(1)-16(n). The context data can comprise reasons to engage with a prospect, message tone for the communication with the prospect, and a length for the communication.

Reasons to engage with the prospect can include that a lease is expiring, there is headcount growth, there is available funding, a company is hiring, the prospect is moving to hybrid, returning to office, or a custom reason (either provided by the user or known in the art) as illustrated in FIGS. 5-7. In other examples, the composing computing system 12 can use the MLM 36 to generate prepopulated context data (e.g., prepopulated signals or preselected signals) based on the lead data, modify the GUI to include the prepopulated context data, and provide the GUI including the prepopulated context data to the client device at one of the plurality of client devices 16(1)-16(n). The composing computing system 12 can then receive selected context data from the client device at one of the plurality of client devices 16(1)-16(n).

In step 315, the composing computing system 12 can identify suggested content offerings (e.g., offers of reciprocity) based on the context data by extracting content offerings from a database at one of the plurality of databases 14(1)-14(n). The content offerings can comprise online news data, materials, suggested case studies, summaries, potential value propositions, or combinations thereof. In some examples, the composing computing system 12 can execute the prompt composer module 30 to continue the process of generating a prompt by communicating at least a portion of the context data to the content offering suggestion module for the MLM 34 to use to identify the suggested content offerings. In other examples, the composing computing system can execute the content offering suggestion module 34 to use the MLM 36 to identify the suggested content offerings (e.g., suggested case studies or suggested potential value propositions) from among the extracted content offerings based on at least a portion of the context data. The suggested content offerings can be aligned with the extracted topics, online news data, or the context data. If the composing computer system 12 previously received selected topics or selected online news data from among the extracted topics or from among online news data from the client device at one of the plurality of client devices 16(1)-16(n), then the suggested content offerings can be aligned with the selected topics, selected online news data, or the context data.

In a non-limiting example, the composing computing system 12 can modify the GUI to comprise the suggested content offerings, which can then be provided to the client device at one of the plurality of client devices 16(1)-16(n). Then the composing computing system 12 can then receive selected content offerings from among the suggested content offerings from the client device at one of the plurality of client devices 16(1)-16(n) for the generation of the prompt.

The composing computing system 12 can execute the prompt composer module 30 to generate the prompt based on the context data, the selected topics, the selected content offerings, the extracted topics, the suggested content offerings, or combinations thereof. The prompt can comprise instructions comprising a concatenation of strings. The composing computing system 12 can generate the concatenation of strings using the context data, the selected topics, selected online news data, the selected content offerings, the extracted topics, the online news data, the suggested content offerings, or combinations thereof. The instructions can include a predefined base string that are basic instructions for the natural language processor or MLM 36 to generate an outreach communication.

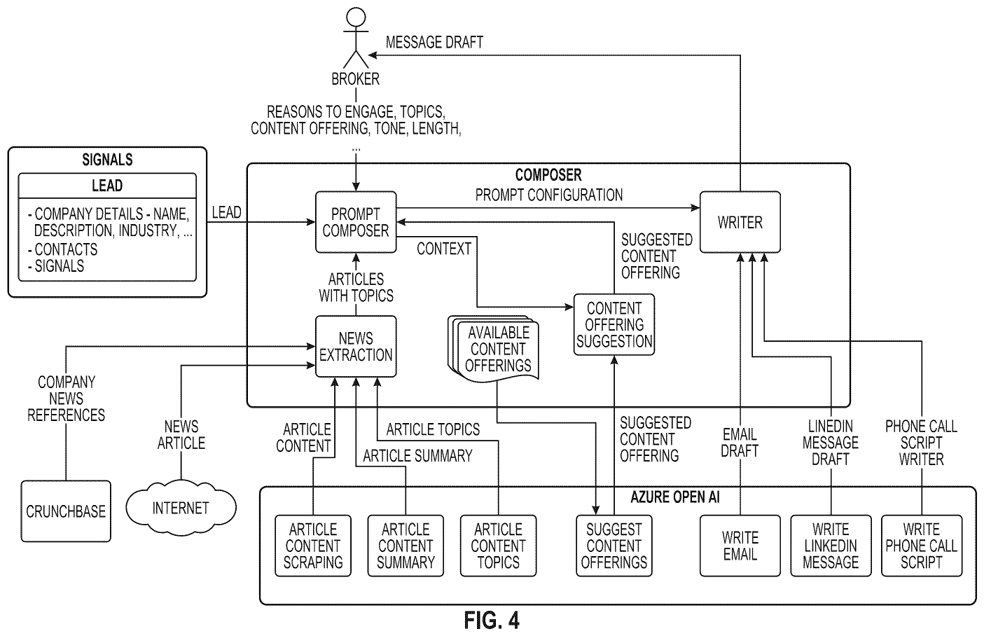

In step 320, the composing computing system 12 can generate a communication based on the prompt by executing the writer module 31. The writer module can be configured to provide the prompt as an input to the MLM 36 by transmitting an API call to the MLM 36 with the prompt as a parameter. The MLM 36 can be configured to analyze prompts comprising instructions to generate communications. The prompt provided as the parameter can include the instructions including the predefined base string which can signal the MLM 36 to process the context data, the selected topics, the selected content offerings, the extracted topics, the suggested content offerings, or combinations thereof in the prompt and to generate the communication by: tokenizing the data in the prompt and identifying key elements and sentiments within the data. The MLM 36 can be trained to identify key elements and sentiments using a large dataset of sample data and pre-generated communications. The natural language processor can then generate the communications using the identified key elements and sentiments. The composing computing system 12 can then receive a response from the MLM 36 with the communication. The MLM 36 can also be configured to ensure the communication adheres to best practices for message length (e.g., extra short, short, grande), offerings of selected reciprocity (e.g., materials that the prospect may find enticing such as achieving a purposeful workplace, future tech office, etc.), tones, and compliance based on the context data, the selected topics, the selected content offerings, the extracted topics, the suggested content offerings, or combinations thereof. The communication can be an email, social media message, LinkedIn message, a phone call script, or other communications known in the art as illustrated in FIG. 4. The composing computing system 12 can then store the communication in a centralized repository at one of the databases 14(1)-14(n).

In step 325, the composing computing system 12 can modify the GUI to comprise the communication and provide the GUI to the client device at one of the plurality of client devices 16(1)-16(n) as illustrated in FIG. 8. The composing computing system 12 can provide the communication to the client device at one of the plurality of client devices 16(1)-16(n), via integration with a native e-mail client application, social media application, or SMS messaging application. After receiving the GUI comprising the communication, the client device at one of the plurality of client devices 16(1)-16(n) can provide feedback by transmitting a selected message length, a selected tone, a selected intro tone to the composing computing system 12 as illustrated in FIG. 8. The composing computing system 12 can then regenerate a revised communication using the MLM 36 using the selected message length, the selected tone, and the selected intro tone and modify the GUI to comprise the revised communication and provide the GUI to the client device at one of the plurality of client devices 16(1)-16(n). The user at the client device at one of the plurality of client devices 16(1)-16(n) can modify the communication if needed prior to transmitting the communication or the revised communication to the prospect at the second client device at the other one of the plurality of client devices 16(1)-16(n). Then, the client device at one of the plurality of client devices 16(1)-16(n) can transmit the communication to the prospect at a second client device at another one of the plurality of client devices 16(1)-16(n).

The composing computing system 12 can monitor the communication via integration with the native client application to determine whether the client device at one of the plurality of client devices 16(1)-16(n) receives a response from the second client device at the other one of the plurality of client devices 16(1)-16(n). The response may be text data and, in some examples, have a positive, neutral, or negative tone. The composing computing system 12 can use the MLM 36 to analyze the text data to extract feedback to facilitate continuous learning and improvement of the MLM 36. Examples of the technology leverage a specially trained AI model (MLM 36) with continuous learning to automatically prepare draft electronic communications that can be used by brokers for prospecting via a native e-mail application, social media application, or SMS messaging, as well as scripting for phone conversations. Additionally, the composing computing system 12 updates the MLM 36 based on what emails are sent to the second client device at the other one of the plurality of client devices 16(1)-16(n) or responded to by the second client device at the other one of the plurality of client devices 16(1)-16(n), ensuring the MLM 36 remains current and effective. At step 330, the exemplary process terminates.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

1. A method comprising:
generating, using a machine learning model (MLM), a summary of relevant data scraped from online news data;
extracting, using the MLM, topics from the summary of the relevant data;
identifying, using the MLM, suggested content offerings based on context data, wherein the suggested content offerings are aligned with the extracted topics and the context data is received from a computing device; and
generating and providing, using the MLM, a communication based on a prompt as an automated outreach communication to a user at a client device, wherein the prompt is generated using the context data, the topics, the suggested content offerings, or combinations thereof, wherein the MLM is configured to use natural language processing to generate the communication, and wherein the communication (i) meets requirements of the context data, and (ii) comprises the topics and suggested content offerings.

2. The method as set forth in claim 1, wherein the context data comprises reasons to engage with a prospect, message tone for the communication with the prospect, and a length for the communication.

3. The method as set forth in claim 1, wherein the topics are provided to the client device via the graphical user interface, and wherein the computing device received selected topics from the client device for the generation of the prompt.

4. The method as set forth in claim 1, wherein content offerings are extracted from a database and wherein the suggested content offerings are identified from among the extracted content offerings.

5. The method as set forth in claim 4, wherein the content offerings comprise case studies, potential value propositions, or combinations thereof.

6. The method as set forth in claim 4, wherein the suggested content offerings are provided to the client device via the graphical user interface, and wherein the computing device received selected content offerings from the client device from among the suggested content offerings for the generation of the prompt.

7. The method as set forth in claim 1, wherein the online news data are retrieved from a database based on lead data and wherein the lead data identifies a prospect for the communication.

8. A composing computing system comprising:
one or more processors;
a memory comprising programmed instructions stored thereon, the one or more processors configured to be capable of executing the stored programmed instructions to:
generate, using a machine learning model (MLM), a summary of relevant data scraped from online news data;
extract, using the MLM, topics from the summary of the relevant data;
identify, using the MLM, suggested content offerings based on context data, wherein the suggested content offerings are aligned with the extracted topics and the context data is received from a computing device; and
generate and provide, using the MLM, a communication based on a prompt as an automated outreach communication to a user at a client device, wherein the prompt is generated using the context data, the topics, the suggested content offerings, or combinations thereof, wherein the MLM is configured to use natural language processing to generate the communication, and wherein the communication (i) meets requirements of the context data, and (ii) comprises the topics and suggested content offerings.

9. The system as set forth in claim 8, wherein the context data comprises reasons to engage with a prospect, message tone for the communication with the prospect, and a length for the communication.

10. The system as set forth in claim 8, wherein the topics are provided to the client device via the graphical user interface, and wherein the computing device received selected topics from the client device for the generation of the prompt.

11. The system as set forth in claim 8, wherein content offerings are extracted from a database and wherein the suggested content offerings are identified from among the extracted content offerings.

12. The system as set forth in claim 11, wherein the content offerings comprise case studies, potential value propositions, or combinations thereof.

13. The system as set forth in claim 11, wherein the suggested content offerings are provided to the client device via the graphical user interface, and wherein the computing device received selected content offerings from the client device from among the suggested content offerings for the generation of the prompt.

14. The system as set forth in claim 8, wherein the online news data are retrieved from a database based on lead data and wherein the lead data identifies a prospect for the communication.

15. A non-transitory computer readable medium having stored thereon instructions comprising executable code which when executed by one or more processors, causes the one or more processors to:
generate, using a machine learning model (MLM), a summary of relevant data scraped from online news data;
extract, using the MLM, topics from the summary of the relevant data;
identify, using the MLM, suggested content offerings based on context data, wherein the suggested content offerings are aligned with the extracted topics and the context data is received from a computing device; and
generate and provide, using the MLM, a communication based on a prompt as an automated outreach communication to a user at a client device, wherein the prompt is generated using the context data, the topics, the suggested content offerings, or combinations thereof, wherein the MLM is configured to use natural language processing to generate the communication, and wherein the communication (i) meets requirements of the context data, and (ii) comprises the topics and suggested content offerings.

16. The medium as set forth in claim 15, wherein the context data comprises reasons to engage with a prospect, message tone for the communication with the prospect, and a length for the communication.

17. The medium as set forth in claim 15, wherein the topics are provided to the client device via the graphical user interface, and wherein the computing device received selected topics from the client device for the generation of the prompt.

18. The medium as set forth in claim 15, wherein content offerings are extracted from a database and wherein the suggested content offerings are identified from among the extracted content offerings.

19. The medium as set forth in claim 18, wherein the suggested content offerings are provided to the client device via the graphical user interface, and wherein the computing device received selected content offerings from the client device from among the suggested content offerings for the generation of the prompt.

20. The medium as set forth in claim 15, wherein the online news data are retrieved from a database based on lead data and wherein the lead data identifies a prospect for the communication.
